(19) United States
(12) Patent Application Publication
(10) Pub. No.: US 2019/0078833 A1
(43) Pub. Date: Mar. 14, 2019

(54) Cloud-based energy saving method for walk-in refrigerators

(71) Applicant: Visible Energy, Inc., Palo Alto, CA (US)

(72) Inventor: Marco Emilio Graziano, Palo Alto, CA (US)

(73) Assignee: Visible Energy, Inc., Palo Alto, CA (US)

(21) Appl. No.: 15/702,265

(22) Filed: Sep. 12, 2017

(51) Int. Cl. F25D 23/02; H04L 12/28; F25D 29/00

(52) U.S. Cl. CPC F25D 23/028; H04L 12/282; F25D 13/00; H04L 12/2838; F25D 29/005

(57) ABSTRACT

A method operating in a cloud environment to predict refrigerator usage and adjust on and off cycles accordingly to reduce energy consumption comprising of: a wireless communicating thermostat to control a walk-in refrigerator system; a wireless communicating door opening sensor; a machine-learning behavioral analysis predictive model to detect refrigerator usage; a strategy to use usage prediction to adjust the refrigerator thermostat set points to limit energy losses determined by infiltration of ambient warm air the refrigerated room.

### BACKGROUND OF THE INVENTION

### Field of the Invention

The present invention pertains to the art of refrigerated apparatus, and more particularly to a temperature control and door sensor apparatus for walk-in refrigerators that interact with a software task in a cloud-computing environment to optimize energy consumption of walk-in refrigeration unit by monitoring and adjusting various operational parameters in a cloud computing environment.

More specifically, the present invention relates to the functional integration of a wireless thermostat in the refrigeration unit, a wireless door contact sensor to sense status of the door being opened or closed, and software in a cloud computing environment to analyze the sensor readings, predict future door openings and to adjust the thermostat settings accordingly, reducing the energy usage of the walk-in refrigerator as result.

### Related Art

Walk-in refrigerators for commercial use operate a vapor compression cycle in which the closed-circuit refrigerant, liquefied from compression, transitions to gas within an evaporator unit, drawing heat through close contact with the air in the refrigerator room. By design, heat of vaporization from the refrigerant's gas phase change effects the extraction of heat from the inside the refrigerator room to a condensing unit in order to maintain room temperature within a desired range.

The walk-in refrigerator components for the gas compression cycle include a compressor, a condensing unit, one or more evaporating units along with an associated fan, and one or more sensors that measure temperature in the room. Additional components may include an evaporator defrost heater.

A thermostat or a temperature control unit assures that the room temperature is around a desired set point by starting and stopping the compression cycle based on input from the temperature sensors. Temperature control in walk-in refrigerators equipped with on-off, fixed speed compressors is typically achieved by means of the classical relay feedback closed-loop.

Techniques such as cloud computing systems have begun to be utilized for a variety of applications. Cloud computing relocates the execution of applications, deployment of services and storage of data to a server farm, typically off premises and implemented as a service. Applications such as remote control software that have been running on conventional server environments have begun to be hosted in the cloud and utilized as services. Providing a service as hosted in a cloud platform results in an operational advantage, since management of hardware for each remotely controlled device becomes unnecessary by arranging the control server on a large-scale server farm. Among other merits, addition of resources depending on a load of the application is easily performed.

### SUMMARY OF THE INVENTION

The present invention overcomes the limitations of current art, with respect to the use of a usage predictive model and the adoption of a remotely controlled thermostat to take advantage of such predictions, to reduce energy consumption of walk-in refrigerators.

It accomplishes this by providing a predictive method used in a cloud computing environment to remotely control and adjust temperature and compressor cycles of a walk-in refrigerator as a function of usage, by using a machine-learning model to predict the time of door openings and their durations, and periodically adjust the thermostat set-points according to such predictions to reduce energy consumption of the walk-in refrigerator.

A refrigerated apparatus constructed in accordance with the present invention includes a thermostat and a door sensor unit both equipped with a network interface such as Wi-Fi (IEEE 802.11), GSM/UMTS/LTE, 5G carrier networks, or Ethernet (IEEE 802.3), and firmware in such units that allows secure communication with the cloud computing software for sending door status and temperature data, and for the thermostat to receiving commands for relay on-off operations or other forms of sensing and control.

The connected thermostat subject of this invention is monitored and regulated by a cloud computing environment to adjust the temperature set points and regulate the compressor cycles of a walk-in refrigerator based on predicted usage requirements.

The thermostat would insure proper functioning in the event of a temporary interruption of the network connection, and the consequent inability to receive control signals, for instance by using safe temperature set points as a conventional refrigerator while the connection is lost.

Still another object of the present invention is to supply a connected door opening sensor which incorporates a switch such as a magnetic contact mounted on the compartment door and door frame to sense status of the door being opened or closed, sending to a cloud computing environment door opening and closing events of a walk-in refrigerator in real-time, for use in the machine-learning predictive method subject of this invention.

Other embodiments, aspects, and advantages of the present invention will become apparent from the following descriptions and accompanying drawings.

### BACKGROUND OF THE INVENTION

### Thermostat

Function of a thermostat in a walk-in refrigerator is to maintain the room air temperature within a defined range to preserve perishable content. A temperature probe or a sensor in the thermostat provides the room air temperature as needed.

Most walk-in refrigerators for the food industry are built with a combined compressor and condenser unit located outside, most often as a rooftop unit. The evaporator coil with the heat exchange, the evaporator fan and the thermostat are instead inside the refrigerated room. In this kind of walk-in refrigeration systems there is also a solenoid valve and a low-pressure cutout switch to control the compressor on and off cycles.

Unlike a thermostat of most refrigerators, in this kind of walk-in units, the thermostat controls the switching circuit of the solenoid valve connected to the liquid refrigerant line inside the refrigerated room to regulate refrigerant flow from the condenser to the expansion valve and the evaporator coil. The low-pressure cutout switch is used to energize and de-energize the compressor and to control its cycles.

When the temperature in the room raises above the cut-in set point, typically between 35° F. and 40° F. in a food walk-in cooler, a compressor cycle is started to cool the air in the refrigerator room (“on” cycle).

When the temperature decreases below the cut-off set point, the thermostat switch opens and power to the liquid line solenoid is removed, closing the valve and stopping the flow of liquid refrigerant to the expansion valve and the evaporator coil. The compressor will continue to run, pulling refrigerant out of the evaporator coil until the suction pressure reaches the low pressure cutout switch setting. Once the cutout pressure is reached, the low-pressure cutout switch de-energizes the compressor and the cooling stops (“off” cycle).

The on and off cycles continue as the refrigerator room is not an isolated thermodynamic system and heat is exchanged through the walls and the walk-in door, particularly when the door is open for loading and unloading operations. Eventually, the temperature rises above the cut-in set point, causing the thermostat to close the switch of the solenoid valve, building back pressure in the refrigerant line, that itself turns off the low pressure cut-out, and the compressor starts again.

The reasons for using a solenoid valve and a low pressure cutout switch, instead of switching on and off the electrical circuit of the compressor/condenser unit, is to pump down and store all the refrigerant into the condenser and receiver during an off cycle, to avoid liquid refrigerant to flood the evaporator coil during off cycles, flooding that would damage the compressor at restart. This is a possibility in a walk-in refrigerator more than in other kind of refrigerators, because the outdoor temperature of the condenser could drop below the room temperature.

The thermostat comprised in the present invention is using a permanent, encrypted connection to the cloud computing environment and it is provided with firmware for a two-way communication, for instance in the form of “remote procedure call”, that allows the cloud software to have the thermostat executing local procedures with parameters provided by the cloud software itself. Exemplary remote procedures execution include a way for the cloud software to change the temperature set points of the thermostat, to request the current temperature of the connected temperature sensor, or to determine the opening or closing of the thermostat relay.

In addition to remote procedures execution, the connection to the cloud computing environment is used by the thermostat to send room's temperature sensors readings and door events in the form of time series, that is at regular intervals and time-stamped.

### Door Sensor

A door sensing element, typically a magnetic contact composed of two elements each with a magnet of opposite polarity, is used to switch a low-voltage electric circuit depending on proximity of one element to the other.

Mounting one element to the door frame and the other to the door itself, door opening and closing events can be detected by the switching of the electric circuit and used by firmware running in a microcontroller terminating the electric circuit into a digital input pin of said microcontroller.

Existing walk-in refrigerator do not have door sensors as it is very unlikely that access to the refrigerated room needs to be monitored for opening and closing. The present invention comprises a commercially available door opening contact sensor for walk-in refrigerators, connected to a wireless data communication unit that sends any opening and closing event to the computing cloud in real-time, for storing such information in the cloud storage.

### Sensor Data

The thermostat sensor data communication unit is using an encrypted connection to the cloud computing environment and as door events are detected by the firmware, for instance by handling an interrupt signal associated to the input level of the digital line connected to the contact sensor. The events are sent upstream to the cloud computing environment, as they are detected in the form of a message comprised of event type, device universally unique identifier (UUID), and a timestamp of the event itself.

Similarly, the thermostat firmware is also sending at regular intervals, sensor data events treated the same way as door events and as time series. Such readings include room temperature sensors and reading from other optional sensors and status of the thermostat itself.

Once in the cloud computing environment, the time series of the individual refrigerator door events and other sensors, are stored in a persistent database for analysis, tabulation and visualization.

### Predictive Model

A software model in the cloud environment based on machine learning such as a supervised ANN (Artificial Neural Network) trained with the time-series data acquired from the refrigerator door sensor messages for each walk-in refrigerator. Training of the ANN is based on the time series as well as other features, such as day of the week, hours of operation, holidays, booking of the establishment or other schedules that provide a quantitative measure of expected business and an indirect indicator of walk-in usage for the day.

The predictive model is executed regularly to predict the amount of time the walk-in refrigerator door is going to stay open for the next period or a number of near future periods of the day, in between predictions. Such predictions are provided by the model in terms of a categorical estimate for the walk-in refrigerator usage, for instance in one of the following three categorical values: “no usage”, “regular”, “high”.

One way to determine the categories of refrigeration usage would be assign each category a range of opening over period duration ratios. For instance, “high” usage label correspond to a total amount of time the door is open that is more than 0.4. Meaning that if the prediction period is of 15 minutes, or 900 seconds, in a period labeled as “high” the door would be open for more than 360 seconds, or 6 minutes. Following this example, the “regular” and “low” usage labels can have a value respectively of 0.2 and 0.1, corresponding to 180 seconds and 90 seconds of door opening time.

Following the prediction, the software in the cloud computing environment performs a remote procedure call for the thermostat in the same walk-in refrigerator, to set the temperature set points in a way to take in account the predicted amount of time the door will stay open and to limit the energy wasted during the period of the day as result of door openings.

This process is repeated for each pre-defined and configurable period of time. During every period of operating the walk-in refrigerator, the actual amount of time the door stays open is measured based on opening and closing events received from the door sensor, and the estimate provided by the predictive model is compared with the actual opening time. This information is used to evaluate the model performance, and to decide whether additional training is needed, how well to trust future predictions, and to apply reinforcement learning strategies to improve the model itself.

The model determining the strategy to change the set points in the cloud environment is taking in account specific factors—machine learning “features”—of each walk-in refrigerator such us, the room volume, the power of the compressor motor, the geographical location, the kind of foodstuff or content stored and its amount.

Determining the optimal set points according to predicted door opening time and the other “features”, is based on the fact that foodstuff acts as energy storage and that a long period of door opening can be preceded by a period of higher than normal cooling, to store more energy in the foodstuff. While the walk-in door stays open, the optimal set point is such to minimize and possibly eliminating any “on” cycle of the compressor, as all the energy used to operate the compressor is going to be wasted to compensate the heat in the warmer air flowing from the ambient into the colder walk-in room.

### BRIEF DESCRIPTION OF THE DRAWINGS

For a more complete understanding of the present invention and for further features and advantages, reference is now made to the following description taken in conjunction with the accompanying drawings, in which:

FIG. 1 is a block diagram of an exemplary cloud-based refrigeration system, according to one embodiment of the present invention.

FIG. 2 is a block diagram of an exemplary connected thermostat, according to one embodiment of the present invention.

FIG. 3 is a block diagram of an exemplary connected door sensor, according to one embodiment of the present invention.

FIG. 4 is a chart of the temperature of a walk-in refrigerator room plotted over time, illustrating the operating temperature range typical of the hysteresis control (“bang-bang”) whereby the compressor is either on or off while the room temperature is within the set points.

FIG. 5 is a chart of the door open or closed status of a walk-in door plotted as a square wave over a period of time of approximately one hour, and divided in 5 periods of 15 minutes each. Below the square wave showing the door opening status, the room temperature of the refrigerator is plotted over the same period of time.

FIG. 6 is a chart of typical walk-in room temperature operating with the thermostat subject of this invention. Once usage patterns are identified, different set points are used for “high” and “low” periods of usage with the walk-in refrigerator operating in different temperature ranges.

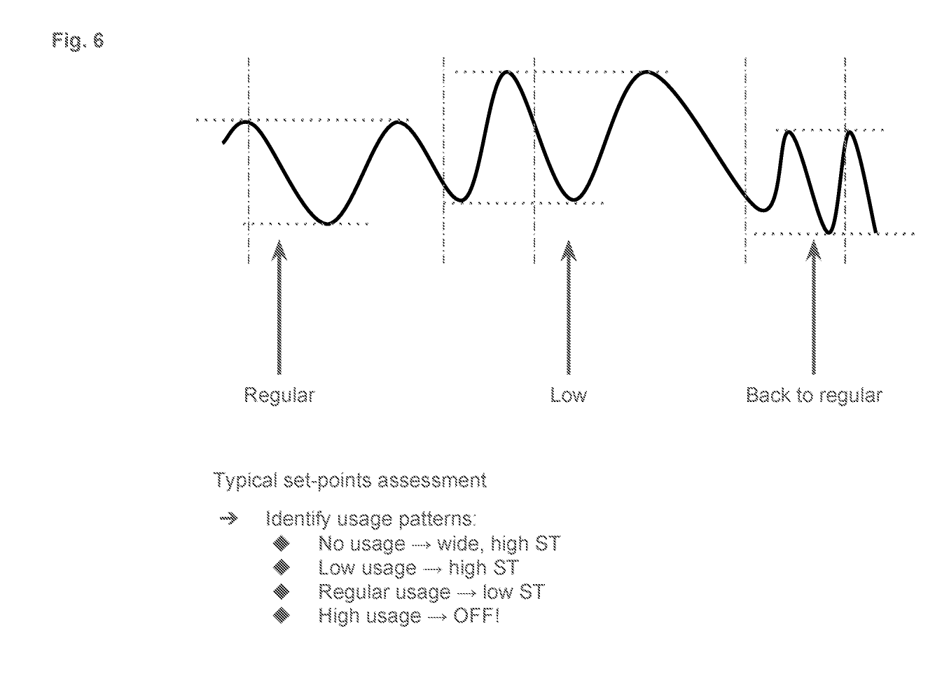

### DETAILED DESCRIPTION OF THE INVENTION

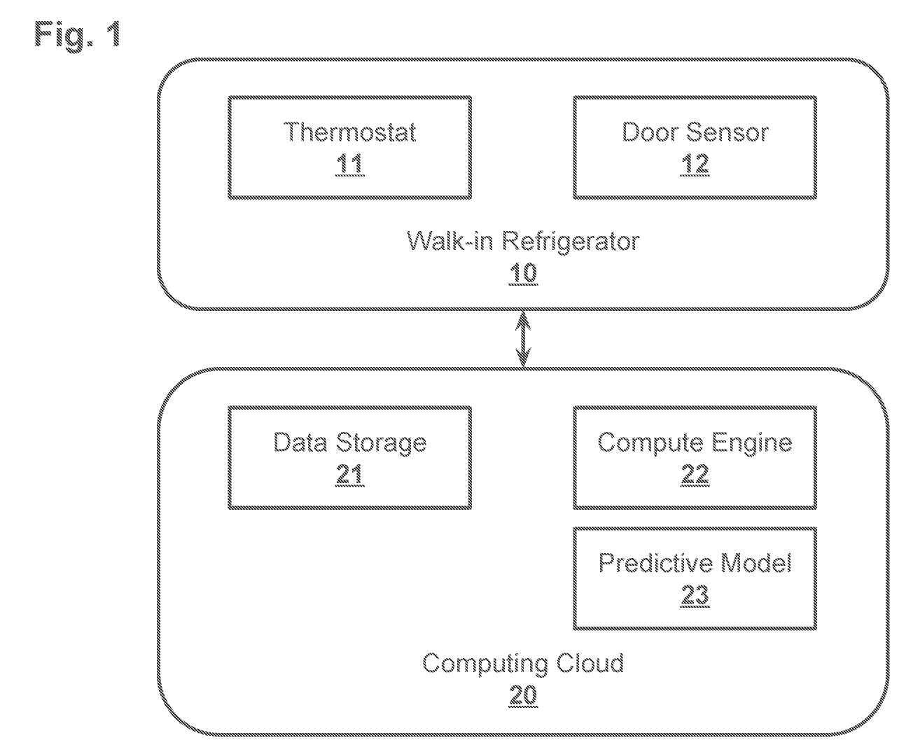

The preferred embodiments of the present invention and their advantages are best understood by referring to FIGS. 1 through 3 of the drawings provided below.

### System Architecture

FIG. 1 is a block diagram of an exemplary cloud-based, distributed control for walk-in refrigerators according to this disclosure. In this diagram, one or more refrigerated apparatus 10 are connected to a computing cloud 20.

One innovative aspect of this disclosure is the ability to deploy software in the computing cloud to control the temperature and other functions of a walk-in refrigerator. The software executing in compute engine 22 acquires sensor data from the walk-in refrigerators 10 as needed, determines the predicted refrigerator usage using predictive model 23, and sends to the thermostat the cut-in and cut-out set points for the following operating period. Such prediction and interaction occurs at regular period of times that are part of the configuration data of the walk-in refrigerator and stored in data storage 21 as part of the equipment inventory database.

One advantage of the disclosed approach is that refrigerator usage is taken in consideration in deciding the optimal operating temperature set points with respect to energy consumption and while continuously monitoring the room temperature to insure safety of the contents.

The predictive model 23 is based on a ANN (Artificial Neural Network) trained on data acquired by computing cloud 20 from the door sensor 12 that detects each door opening and closing event and communicates in real-time such events to computing cloud 20 for storing them in data storage 21.

In some embodiments of this disclosure, one software task executed in the computing cloud's compute engine 30, with its own private execution and data context, is instantiated in the computing cloud for each controlled walk-in refrigerator 10 to perform the predictive model training of that refrigerated apparatus.

The computing cloud 20 is accessible from remote locations and includes at least one compute engine 22 and at least one data storage unit 21. The computing cloud 20 is capable of both storing information in data storage 21 and performing data functions of information in compute engine 30, as well as to interact with external services.

The walk-in refrigerator 10 communicates with the computing cloud 20 using any secured or unsecured protocol, such as the Transport Layer Security (TLS) or any other socket-based communication protocol. The communication between the refrigerated apparatus 10 and the computing cloud 20 is “bidirectional”, that is data is sent and received by both ends.

The computing cloud 20 includes hardware that does not fit and is cost-prohibitive to incorporate in individual walk-in refrigerator 10. Moreover, the computing cloud 20 includes software that would not run or would be cost prohibitive to incorporate in individual walk-in refrigerator 10. Therefore, the computing cloud 20 provides this hardware and software resources through secure connections to acquire door opening events and walk-in refrigerator room temperature. At regular interval of time, computing cloud 20 performs model training and predicts future usage to decide optimal temperature set points for refrigerated apparatus 10. Such optimal set points are then communicated to thermostat 11 to allow for optimal operation for the period. The thermostat is capable to store operating set points as received by computing cloud 20 and to use backup values in case communication with such computing cloud 20 is temporarily unavailable. Thermostat 11 is also sending the room temperature to the computing cloud 20 at regular intervals, to monitor usage and provide data analytics regarding the walk-in refrigerator operations.

One of the innovative features of this disclosure is to take advantage of the computational resources in the computing cloud 20 to incorporate non-linear (ANN) and time variant control strategies, including methods and models to minimize energy consumption, and to incorporate data analysis to operate the walk-in refrigerator.

Moreover, the model may be individually selected for each walk-in refrigerator 10, according to its expected use and location to obtain higher energy efficiency, and adapted to account for local and changing environmental and operational conditions.

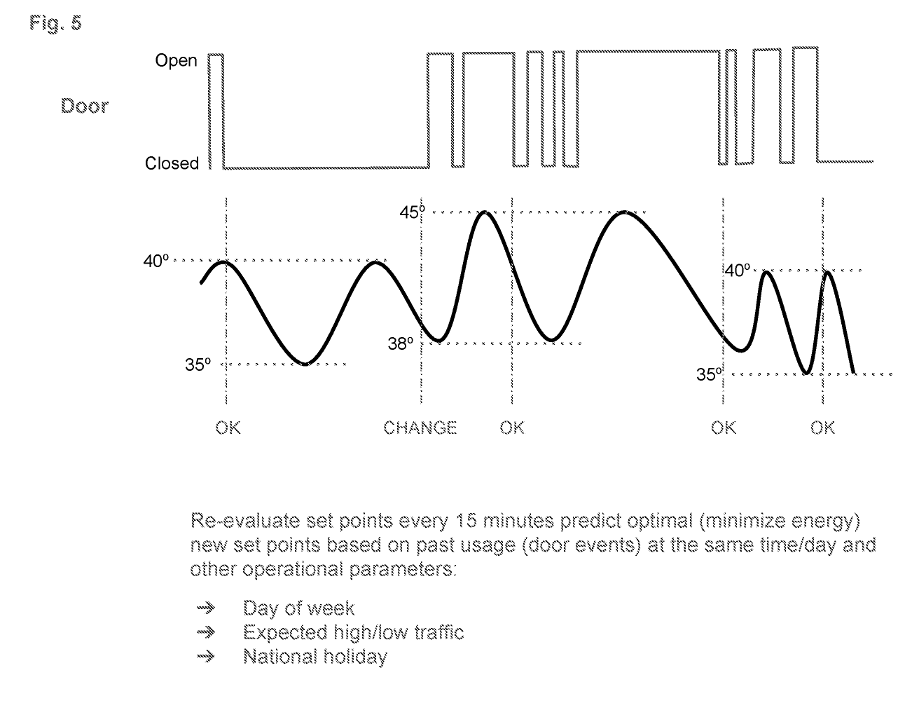

The diagram in FIG. 5 is indicative of how there are different periods of usage of a walk-in refrigerator during a day and it illustrates the basic principles of how the thermostat and predictive model subject of the present invention operates. Objective of the predictive model used in the invention, is to detect usage patterns that repeat at or around the same time of day, every day of the week or under similar exogenous conditions. In the 5 periods of time of FIG. 5, periods 1 and 5 are classified as “low” usage, periods 2 and 3 as “high” and period 4 as “regular”. This is repeated every day the same during the same period T.

Set points are evaluated by compute engine 22 every period of the day T based on whether the usage prediction for the following period T+1 is of the same category of the current period T or not. Once a change in usage is predicted, at the beginning of period T+1 a new range for the set points is determined by the software method in cloud compute engine 22, and a “remote procedure call” is executed to communicate and set the new set points in the corresponding communicating thermostat 11 that is capable of operating at different temperature set points.

Different criteria can be used to decide how values for the set points are calculated and the criteria can change over time as a function of season, type of perishable content stored in the walk-in refrigerator or type of commercial establishment. As an example, referring to FIG. 5, once at period 2 a “high” usage is predicted, the set points are set in a way to keep the compressor off for the whole duration of the period. The rationale being that while the door is open for a long period of time, most of the energy used to operate the compressor and to cool the room air is lost through the drift of the external warmer air into the room, and that it would make little sense to trying to lower the room temperature while under such conditions.

Reaching period 3 and receiving a prediction for another “high” usage period, considering that period 2 was already “high” and effectively the compressor remained off, the current room temperature is acquired and it is determined whether another “high” usage period with the compressor off is safe or not.

At the end of period 3 with a “normal” prediction for period 4, the set points are set back to their “normal” range and at the end of period 4 with a “low” usage prediction a range of set points that allow the temperature to swing over a wider range (“dead-band”) is set.

In some embodiments, the control algorithm may leverage the service-oriented architecture of the cloud computing 20 to access data or other computational and resources available from external services, such as weather forecast for the locations of walk-in refrigerator apparatus 10, details of relevant events such as receiving new material or foodstuff to be stored in a walk-in refrigerator from a shipping company, reservation or other kind of scheduling or data to predict occupancy and volume of business of the establishment the walk-in refrigerator is operating in, price or demand-response signals from utilities or other requests related to the operation of a smart-grid and the need for electric load shaving and shifting.

Thermostat

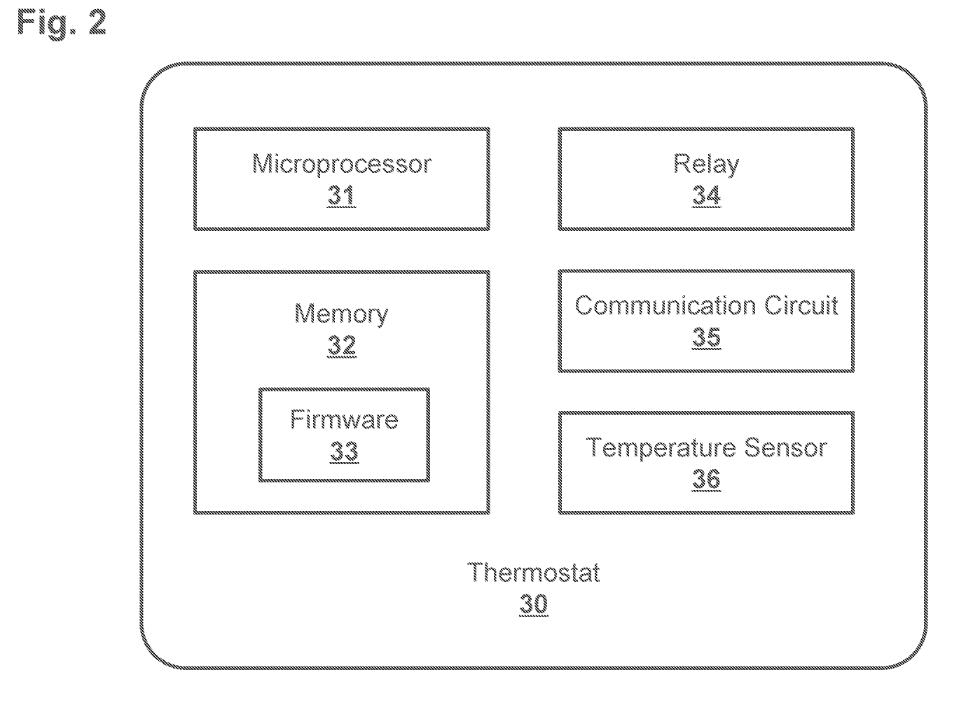

FIG. 2 is the block diagram of an exemplary thermostat for a walk-in refrigerator with a cloud-based control method, according to some embodiments of the present invention.

Thermostat 30 includes a microprocessor 31 capable of executing firmware 33 stored in memory 32, a relay 34, a temperature sensor 36, and a communication circuit 35 used to connect to cloud computing 20. The thermostat relay 34 controls the on and off cycles of the refrigerator's compressor. The thermostat sensor 36 provides the walk-in refrigerator room's temperature data.

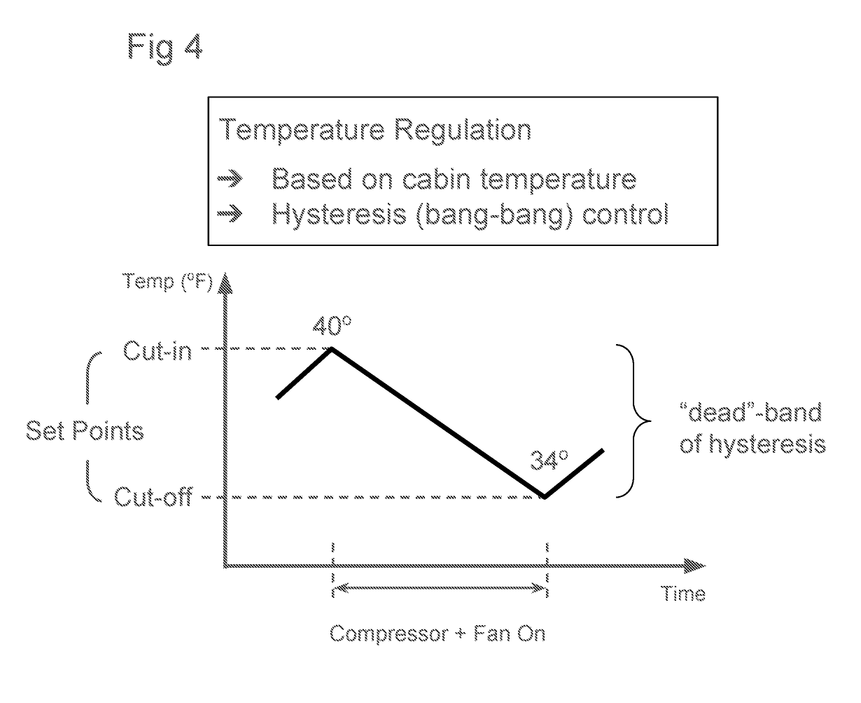

The thermostat firmware 33 incorporates also at least functions to acquire sensor data 36 and control the state of relay 34, to insure the refrigerator room temperature is kept within the cut-in and cut-off set points stored in memory 32 and following a simple hysteresis, closed-loop control method, as illustrated in FIG. 4.

The thermostat firmware 33 incorporates also a function that allows the thermostat to communicate to cloud computing 20 through the communication circuit 35 to allow a software task executed remotely in cloud computing 20 to provide the thermostat operating temperature set points to be stored in memory 32.

The thermostat firmware 33 incorporates also a function that allows the thermostat to communicate to cloud computing 20 through the communication circuit 35 to cloud computing 20 to acquire and store into data storage 21 temperature sensor readings and their timestamps.

Other functions of the refrigerated apparatus firmware 33 include protocol and encryption methods to enable secure communication with cloud computing 20, such as the Transport Layer Security (TLS) protocol.

Thermostat memory 32 stores the firmware 13 and it may store the cut-in and cut-off temperature set points and other configuration data that allow the thermostat communication circuit to connect to gateways or access points in the access network used by the thermostat to connect to cloud computing 20.

Door Sensor

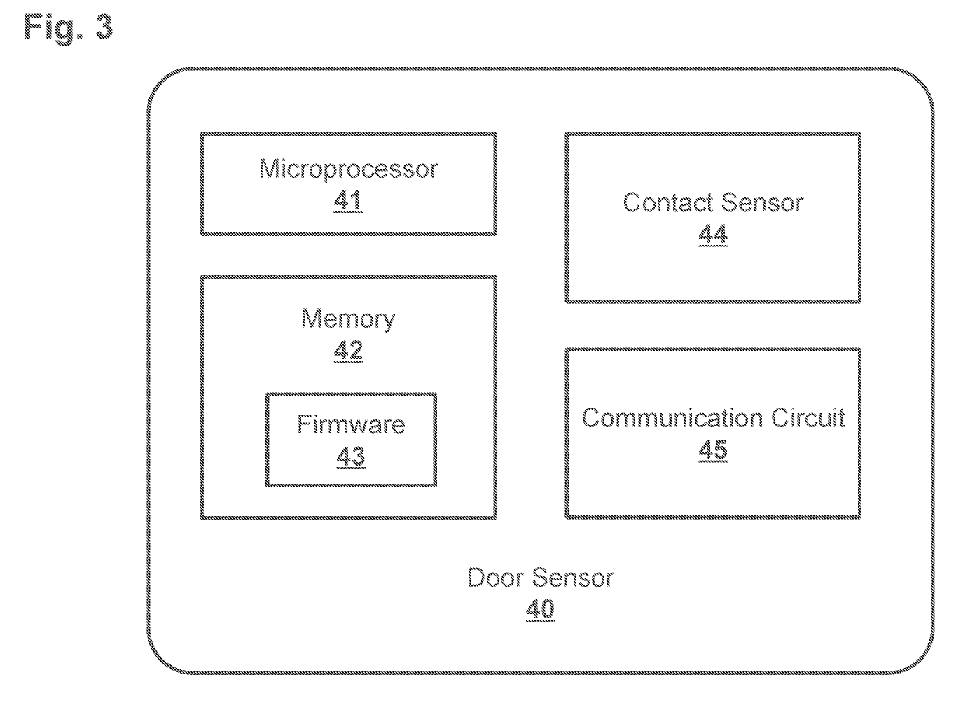

FIG. 3 is the block diagram of an exemplary door sensor for a walk-in refrigerator with a cloud-based control method, according to some embodiments of the present invention.

Door sensor 40 includes a microprocessor 41 capable of executing firmware 43 stored in memory 42, a magnetic contact sensor 44, and a communication circuit 45 used to connect to cloud computing 20.

The door sensor contact sensor 44 is composed of a typical reed switch, sensing the presence of a magnetic field in one of its elements as determined by its proximity, and switching a digital signal. Mounting one magnetic element to the door frame and the other to the door itself, door opening and closing events are detected by the switching of the reed switch.

The door sensor firmware 43 incorporates also at least functions to detect door opening and closing events, by reacting to level changes of the digital input connected to the contact sensor 44.

The door sensor firmware 43 incorporates also a function that allows the thermostat to communicate to cloud computing 20 through the communication circuit 45 to allow a software task executed remotely in cloud computing 20 to acquire and store into data storage 21 door opening and closing events and their timestamps.

Other functions of the door sensor firmware 43 include protocol and encryption methods to enable secure communication with cloud computing 20, such as the Transport Layer Security (TLS) protocol.

### Advantages of Present Invention

From the above description, it should be apparent that the present invention provides at least the following advantages. First, walk-in refrigerator temperature control cut-in and cut-off thermostat set points are not manually set and fixed while operating the walk-in refrigerator.

In commercial settings, the contents of the walk-in refrigerator are frequently accessed; hence the doors of the walk-in are opened frequently. Every time the door is opened, heat is exchanged and warmer ambient air is drafted into the refrigerated room. This infiltration of ambient warm air into the refrigerated room while the door is open, results in raising the interior temperature of the room of the walk-in. This ultimately results in the refrigeration system consuming additional energy to maintain the internal room temperature within the allowed range.

While in existing thermostats the set points are manually set and kept constant while the walk-in refrigerator is in operation, the present invention overcome the limitations of the state of the art, allowing the operating set points to change over time according to a strategy defined by software running in a cloud environment to estimate optimal operating set points to limit energy loss in presence of a door opening, and communicating them to the wireless thermostat in advance according to future predicted usage.

Furthermore, the cloud-based software method described can be provided to walk-in refrigerators manufacturers or end-users as a service, incorporating additional functions such as detection of anomalies, malfunctioning of equipment and notification of exceptions or temperature out of range, to the end-user of the walk-in refrigerator.

The present invention provides for a cloud based energy control system for one or more refrigeration unit assemblies that have a walk in refrigeration unit with a door sensor. The door sensor has multiple magnetic contacts mounted on a refrigeration door frame and also on a walk-in refrigerator door whereby the magnetic contacts can detect the walk-in refrigerator door opening and closing.

In an alternative embodiment, these magnetic contacts can also communicate with one another to acquire time series data. The door sensor also has firmware, memory to store the firmware, and a microprocessor electrically connected to at least one network communication circuit.

The present invention further provides for a wireless thermostat installed in a refrigeration unit and is equipped with firmware, memory to store the firmware, a microprocessor, a temperature sensor, and a plurality of temperature control circuit relay systems installed in the refrigeration unit. The walk-in refrigerator also has a compressor which the thermostat can control the on and off cycles.

The walk-in refrigerator has an access network with one or more gateways and one or more access points to allow for a computing cloud to connect to the thermostat over the network, to allow the computing cloud to receive and store time series data in a data storage server. The computing cloud can use the data to predict optimal set points within the thermostat according to the time series data and a machine learning model. The computing cloud is also capable of performing a remote execution command to communication circuits for controlling the refrigerated apparatus to allow the computing cloud to estimate efficiency of a given refrigerated unit.

In an alternative embodiment, the thermostat can insure proper functioning in the event of a temporary interruption of the network connection by using default temperature set points as a conventional refrigerator while the network connection is unavailable.

In another embodiment, the thermostat may store cut in and cut off temperature set points.

In an alternative embodiment, the computing cloud can communicate with the thermostat using socket based communication protocol and TLS.

In an alternative embodiment, the door sensor and thermostat may utilize a network interface compatible with IEEE 802.11a/b/ac/g/n, GSM/IMTS/LTE, 4G/5G carrier networks, or Ethernet IEEE 802.3

In an alternative embodiment, time series data can be a combination of sub sequences of time series data allowing for a computing cloud to make predictions for optimal energy consumption and to communicate with a thermostat to periodically adjust set points and consequent compressor cycles of the refrigerator assembly.

In an alternative embodiment, a door sensor can have a magnetic contact mounted on a compartment door and the door frame to sense the status of the door being opened or closed.

In an alternative embodiment, the relay in the thermostat can control the on and off cycles of the compressor by switching the circuit of a solenoid valve connected to the refrigeration unit liquid refrigerant line.

Another feature of the present invention is a predictive method for automatically adjusting temperature set points for energy consumption optimization in at least one refrigerated apparatus. This method uses a number of steps to obtain a first set of rules that define time series data acquired from a refrigerator door sensor as a function of door open activity sequence and time of a prediction period sequence.

Further, in an alternative embodiment, the method obtains a timed data file of the time series data of refrigeration unit usage prediction periods having a plurality of sub sequences and then evaluates the plurality of sub sequences against the first set of rules. Next, a refrigeration unit usage prediction engine in the computing cloud is capable of executing a remote procedure call to a wireless thermostat and may further estimate energy consumption optimal set points. The computing cloud can communicate optimal set points to a wireless thermostat in a refrigerated apparatus to minimize overall energy usage.

In an alternative embodiment, the method can feature a first set of rules for refrigeration usage criteria featuring a group of high, medium, or low usage. The method can also have the first set of rules be acquired from a door sensor, which is then communicated via an encrypted message to a computing cloud that is capable of storing a plurality of time series data.

The method may also allow for thermostat set points to be evaluated by a compute engine every period T based on machine learning by an artificial neural network model trained with time series data acquired by the door sensor regarding door opening events or usage level criteria for the period.

In an alternative embodiment, the thermostat can store and operate set points as received by the computing cloud to backup these stored values in case communication with the computing cloud is unavailable. The method may also allow for the step of performing the predictive method to be implemented by a remote cloud execution server according to sensor data from the data storage server obtained by parameters defined by an artificial neural network model.

In an alternative embodiment, sensor data can comprise one or more of refrigerator cabin volume, geographical location, compressor motor power, day of the week, weather forecast, estimated revenues for the establishment that the refrigeration unit is operating in, and the content of foodstuff in the refrigeration unit.

The method also allows for prediction period sequences which are trained on data acquired from the door sensor and communicated to the data storage server on the computing cloud further used to train an artificial neural network model and stored in the data storage server.

While particular embodiments of the present invention and their advantages have been shown and described, it should be understood that various changes, substitutions, and alterations could be made therein without departing from the spirit and scope of the invention.

I claim:

1) A cloud based energy control system for one or more refrigeration unit assemblies comprising:
a) a walk in refrigeration unit;
b) a door opening sensor comprising:
(i) a first magnetic contact mounted on a refrigeration door frame;
(ii) a second magnetic contact on a refrigeration unit door wherein the magnetic contacts detect the refrigeration door opening and closing;
(iii)firmware;
(iv) memory, wherein the memory stores the firmware; and
(v) a microprocessor electrically connected to an at least one network communication circuit;
c) a wireless thermostat respectively installed in the refrigeration unit, the thermostat comprising:
(i) firmware;
(ii) memory, wherein memory stores the firmware;
(iii)a microprocessor;
(iv)a temperature sensor;
(v) at least one relay respectively installed in the refrigerated unit;
d) a compressor wherein the thermostat controls the on and off cycles of the compressor;
e) an access network comprising one or more gateways and one or more access points; and
f) a computing cloud wherein the computing cloud is connected to the thermostat via said network, the computing cloud receiving and storing time series data in a data storage server, predicting optimal set points within the thermostat according to the time series data, and performing a remote execution command to the at least one communication circuit for controlling the refrigerated apparatus, wherein the computing cloud estimates efficiency of the refrigerated unit.

2) The system of claim one, wherein the thermostat insures proper functioning in the event of a temporary interruption of the network connection by using default temperature set points as a conventional refrigerator while the network connection is unavailable.

3) The system of claim one, wherein the thermostat may store cut-in and cut-off temperature set points.

4) The system of claim one, wherein the computing cloud communicates with the thermostat using socket-based communication protocol and Transport Layer Security (TLS).

5) The system of claim five, wherein the door sensor and thermostat both further comprise a network interface compatible with IEEE 802.11a/b/ac/g/n, GSM/IMTS/LTE, 4G/5G carrier networks, or Ethernet IEEE 802.3.

6) The system of claim one, wherein time series data further comprises a plurality of sub sequences of time series data allowing for the computing cloud to make predictions for optimal energy consumption and to communicate with the thermostat to periodically adjust set points and consequent compressor cycles of the refrigerator assembly.

7) The system of claim one, wherein the door sensor further comprises a magnetic contact mounted on the compartment door and door frame to sense status of the door being opened or closed.

8) The system of claim one, wherein the relay in the thermostat controls the on and off cycles of the compressor by switching the circuit of a solenoid valve connected to the refrigeration unit liquid refrigerant line.

9) A predictive method for automatically adjusting temperature set points for energy consumption optimization in at least one refrigerated apparatus comprising the steps of:
a) obtaining a first set of rules that define time series data acquired from a refrigerator door sensor as a function of door open activity sequence and time of a prediction period sequence;
b) obtaining a timed data file of the time series data of refrigeration unit usage prediction periods having a plurality of sub sequences;
c) evaluating the plurality of sub sequences against the first set of rules;
d) a refrigeration unit usage prediction engine in a computing cloud to estimate energy consumption optimal set points; and
e) the computing cloud communicating optimal set points to a thermostat in a refrigerated apparatus to minimize overall energy usage.

10) The method of claim 9, wherein each of said first set of rules comprises refrigeration usage criteria selected from the group consisting of high, medium, or low usage.

11) The method of claim 10, wherein the first set of rules are acquired from a door sensor and are communicated via an encrypted message to a computing cloud to store a plurality of time series data.

12) The method of claim 11, wherein the encrypted message is sent from the thermostat to the computing cloud and further comprises an event type, device universally unique identifier, and timestamp of the event itself.

13) The method of claim 9, wherein the set points are evaluated by a compute engine every period T based on machine learning by an artificial neural network model trained with time series data acquired by the door sensor regarding door opening events or usage level criteria for the period.

14) The method of claim 9, wherein the thermostat is capable to store operating set points as received by the computing cloud and to use these stored values in case communication with the computing cloud is unavailable.

15) The method of claim 9, wherein the step of performing the predictive method is implemented by a remote cloud execution server according to sensor data from the data storage server obtained by parameters defined by an artificial neural network model.

16) The method of claim 15, wherein sensor data further comprises one or more of: refrigerator cabin volume, geographical location, compressor motor power, day of the week, weather forecast, estimated revenues for the establishment the refrigeration unit is operating in, and content of foodstuff in the refrigeration unit.

17) The method of claim 11 wherein prediction period sequences are trained on data acquired from the door sensor and communicated to the data storage server on the computing cloud further used to train an artificial neural network model and stored in the data storage server.
